(19) United States
(12) Patent Application Publication
(10) Pub. No.: US 2003/0231317 A1
(43) Pub. Date: Dec. 18, 2003

(54) System and device for detecting and separating out of position objects during manufacturing process

(75) Inventors: Santos Eliud Sepulveda Carlos, Escobedo (MX); Jose Luis Gonzalez Garza, San Nicolas de los Garza (MX); Sergio Bustamante Salazar, San Nicolas de los Garza (MX)

Correspondence Address: OBLON, SPIVAK, MCCLELLAND, MAIER & NEUSTADT, P.C., 1940 DUKE STREET, ALEXANDRIA, VA, 22314, US

(73) Assignee: Fabricas Monterrey, S.A. de C.V., Monterrey (MX)

(21) Appl. No.: 10/170,622

(22) Filed: Jun. 14, 2002

(51) Int. Cl. G01B 11/14

(52) U.S. Cl. 356/614

(57) ABSTRACT

A system for identifying and separating out-of-position objects on a conveyor belt during a manufacturing process or other material handling process. Upon a detection by a proximity sensor that an object is entering the inspection zone, laser position sensors are used to sense the position of the object. An out-of-position object is either separated from the production flow or repositioned on the conveyor belt.

### BACKGROUND OF THE INVENTION

1. Field of the Invention

The invention relates to a manufacturing process or other material processing operations, and particularly to apparatus and methods for identifying and separating out-of-position objects which are being conveyed.

2. Discussion of the Background

In manufacturing and other material processing operation, problems can arise due to defects in the raw materials or unfavorable operational settings in the machines. Such situations can easily move an object being processed out of position, causing a defective product or operational problems. An object which is out-of-position can lead to wasted raw materials, damaged cutting bits or stamping plates, or jammed machinery. Such situations lead to work flow stoppage and often necessitate expensive repairs. Furthermore, if the problem remains undetected for a period of time, defective products will be intermixed with acceptable products, thus increasing spoilage and defect rates, and possibly affecting customer satisfaction.

### SUMMARY OF THE INVENTION

The present invention has been developed to provide an accurate system for detecting out-of-position objects, allowing non-acceptable objects to be separated from acceptable objects or repositioned for further processing.

The present invention applies to various material processing operations such as manufacturing, production assembly, machine welding, cutting, stamping, canning, bottling, bottlecapping, printing, or other like object conveyance related processes or operations.

One object of the invention is to provide a system for identifying and separating out-of-position objects during a manufacturing process or other material handling operation.

In order to achieve this and other objects, the invention uses a control system device to identify an object which is out-of-position during a conveying step in the material processing operation. An out-of-position object is an object which is not correctly situated, or is improperly oriented (e.g., misaligned) with respect to a reference system being used for the specific material processing system associated with the position detection control system 100.

In accordance with one embodiment, an object is conveyed on a conveyor belt at a predetermined production speed in a production flow direction. A proximity sensor detects when the object enters an inspection zone and communicates a proximity indication to a position detector. The position detector, which can be embodied as two laser sensors, performs a position detection for the object upon receiving the proximity indication from the proximity sensor. The position sensor returns a signal indicating whether the object is out-of-position and requires further measures such as separation from the conveyor belt or repositioning.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a block diagram of a system for identifying and separating out-of-position objects, according to the present invention;

FIG. 2 is a block diagram depicting locations for exemplary embodiments of the present invention in relation to a typical configuration of a conveyance system and a material processing machine; and

FIG. 3 is a flowchart of a method in accordance with the present invention.

### DETAILED DESCRIPTION

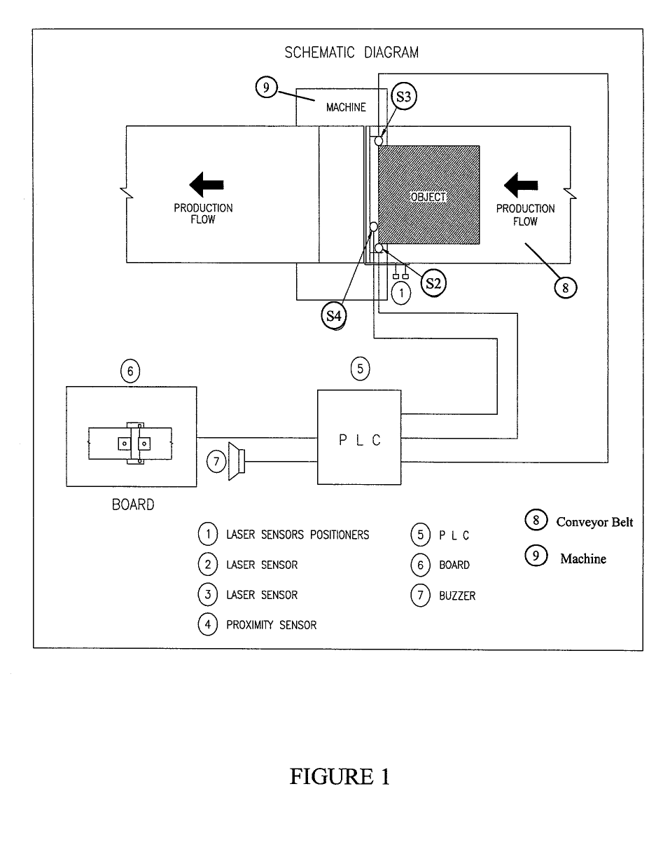

In FIG. 1, a block diagram of a system for identifying and separating out-of-position objects, the position detection control system 100 includes one or more laser sensor positioning mechanisms 1, laser sensors S2 and S3, a proximity sensor S4, a programmable logic controller 5 (PLC), a display board 6, and a buzzer 7. The control system 100 in the figure is shown configured for use with a conveyor belt 8 and a material processing machine 9. Although the embodiment depicted in FIG. 1 shows the position detection control system 100 being used with a conveyor belt 8, the present invention can be used with other type of material conveyance systems as well. For example, the position detection control system 100 typically works in conjunction with a conveyor belt 8 as shown in the figure, or a conveyance system such as a pick-and-place mechanism, a robotic arm, or other like type of material conveyance system known to those of skill in the art. The material processing machine 9 may be any type of machine or device that performs an operation which is position sensitive e.g., a machine for manufacturing, production assembly, printing, cutting, stamping, bottlecapping, canning, welding, or the like. The control system 100 can either be installed permanently to the conveyance system, or can be semi-permanently positioned using removable clamping mechanisms or like types of fastening devices.

Preferred embodiments of the PLC 5 have a special program to process the information received from the sensors. The PLC 5 can be embodied as a computer, a processor, or other type of controller device, logic structure or operational steps. The PLC 5 is typically located proximate the general area of the laser sensors S2 and S3 and display board 6. However, it may be located within an office area of the plant, or even remotely located off-site and configured for remote control of the system. A complicated manufacturing process may have several position detection control systems 100 located at key points along the object's path. In such systems, a single PLC 5 can be configured to control the various components of several detection control systems 100.

One object of the position detection control system 100 is the detection of out-of-position objects as the conveyor advances in the production flow direction. To achieve this, the control system 100 includes two different kinds of sensors. The proximity sensor S4 detects an approaching object which has reached an acceptable position for the inspection, that is, an inspection zone. The inspection zone can be defined as being an area in which position detectors (e.g., laser sensors S2-S4) can be used to detect the position of an object. The proximity sensor S4 can be used to determine if an object has reached the inspection zone. In one embodiment, the maximum detection range of the proximity sensor S4 determines the far edge of the inspection zone, while the near edge of the inspection zone is determined by how far along the conveyor belt 8 the sensors S2 and S3 are able to make a position detection. In alternative embodiments, the proximity sensor S4 can detect an object which is approaching the inspection zone.

One or more laser sensors, e.g., the pair of laser sensors S2 and S3, detect the position of the object. The laser sensors S2 and S3 are preferably mounted on the framework of the conveyor or other part of the conveyance system, next to the material processing system, e.g., manufacturing machine. The laser sensors S2 and S3 are located a predetermined distance away from each other. The predetermined mounting distance depends upon the product dimensions, the mounting configuration of sensors S2, S3 and S4, and the parameters of the conveyance system. The predetermined distance between lasers S2 and S3, and their orientation with respect to each other can be adjusted for products having different dimensions, sizes or shapes, and for the speed of the conveyance system.

The sensors S2-S4 are preferably located far enough away from the material processing system (e.g., manufacturing machine 9) so that an out-of-position object can be dealt with before the conveyance system moves it too far (e.g., into the manufacturing machine). For a conveyance system set to a predetermined conveyance velocity V_{c}, the proximity sensor S4 is located at least a distance D, away from the processing machine, wherein Dₛ is determined by the relationship:

Dₛ=V_{c}×(Aₜ+Pₜ) (1)

In the above relationship, the variable Aₜ represents the separation time, e.g., the time it takes to separate or reposition an object determined to be out-of-position from the conveyance system. The variable Pₜ represents position detection time which includes the actual measure of position plus any processing and signal communication time between the components of the position detection control system 100. For example, Pₜ includes the time it takes for a proximity indication to be generated and communicated from the proximity sensor S4 to the laser sensors S2 and S3 via the PLC 5, the time required for a position detection to be executed by the laser sensors S2 and S3, plus any further time required for providing the out-of-position signal back from the laser sensors S2 and S3.

The laser sensors S2 and S3 are connected to the PLC 5, where the sensor signals are monitored, received and analyzed. The PLC 5, in turn, sends an output signal to the display board 6. Typically, the connections between the various components of position detection control system 100 are hard-wired signal lines running between the devices. Alternatively, an infrared or other wireless link can be used to interconnect one or more of the components of the position detection control system 100. The control system 100 can also be interconnected using a common bus, and a timing or addressing scheme.

Upon receiving a signal indicating of an out-of-position object, the display board 6 denotes the defective object's location within the conveying system. This allows the out-of-position object to be separated or reorientated either manually or through an automatic process. A complicated manufacturing process may have several position detection control systems 100 located at key points along the object's path. In such embodiments, a single display board 6 can be configured to display the results of the several position detection control systems 100. The display board 6 can be embodied in various forms, e.g., as a CRT, LCD or other type of display monitor; a one or more arrow keys indicating a direction of misalignment; as an arrangement of light emitting diodes (LEDs); or as an on/off warning light providing only a binary indication of an out-of-position object.

The laser sensors S2 and S3 detect the occurrence of an out-of-position object for the specific operation or processing machine associated with the position detection control system 100. Whether an object is out-of-position or not can be determined with respect to a number of reference systems, points or objects, in accordance with various embodiments of the present invention. For example, an object can be deemed out-of-position relative to the conveyance system, relative to the material processing system, relative to other objects, relative to the system 100, or relative to an arbitrarily defined coordinate system (e.g., Cartesian coordinates; yaw, pitch and roll; GPS coordinates; or the like).

The sensors S2-S4 are typically located in the proximity of the production flow at the entrance to the material processing machine 9. Alternatively, the sensors S2-S4 can be located anywhere along the conveyance system. In some situations, it is advantageous to locate the sensors far enough away from the entrance of the material handling machine so that out-of-position objects can be removed or repositioned. One or more of the sensors S2-S4 can be adjusted to accommodate objects of various sizes, or to recalibrate or reorient them to maintain accurate readings. In accordance with some embodiments, the adjustment can be performed using the laser sensor positioning mechanism 1 as illustrated in FIG. 1. The sensor positioning mechanism 1 may be embodied with a stepper motor, a solenoid, a piston mechanism, or other like device for moving or reorienting the sensors. In a preferred embodiment, this can either be done using one laser sensor positioning mechanism 1 for each of the sensors S2 and S3, and, in some embodiments, the sensor S4. Alternatively, the adjustment can be performed by having only one of the sensors S2 and S3 equipped with a laser sensor positioning mechanism 1. That is, some of the sensors can be equipped with positioning mechanisms 1 while others are not.

During operation of the position detection control system 100, the proximity sensor S4 provides a proximity indication signifying that the object is in the appropriate inspection zone. The proximity indication is communicated to the laser sensors S2 and S3 which in turn initiate a position detection. In practice, a detection by the proximity sensor S4 can be communicated to the PLC 5, which, in turn, communicates an indication of object proximity to the laser sensors S2 and S3. As illustrated on the FIG. 1, objects advance in a continues process in the flow production direction, as the sensors S3 and S4 detect out-of-position objects. In a preferred embodiment, the PLC 5 uses a program developed for this invention to verify the signals (inputs) from laser sensors S2 and S3, and sends output signals to the display board 6.

The buzzer 7 can also be provided to indicate an objected detected to be out-of position. Upon detecting an out-of-position object with the laser sensors S2 and S3, the buzzer 7 turns ON, and turn OFF after the defective product has been separated from the conveyance system, or otherwise ameliorated (e.g., reoriented, repositioned, or otherwise corrected). The step of separating the object can comprise a step of temporarily slowing down the conveyance system until the out-of-position object has been dealt with. Regarding the buzzer 7, in an alternative embodiment the buzzer 7 is turned OFF after a predetermined amount of time regardless of whether the out-of-position object has been separated or not.

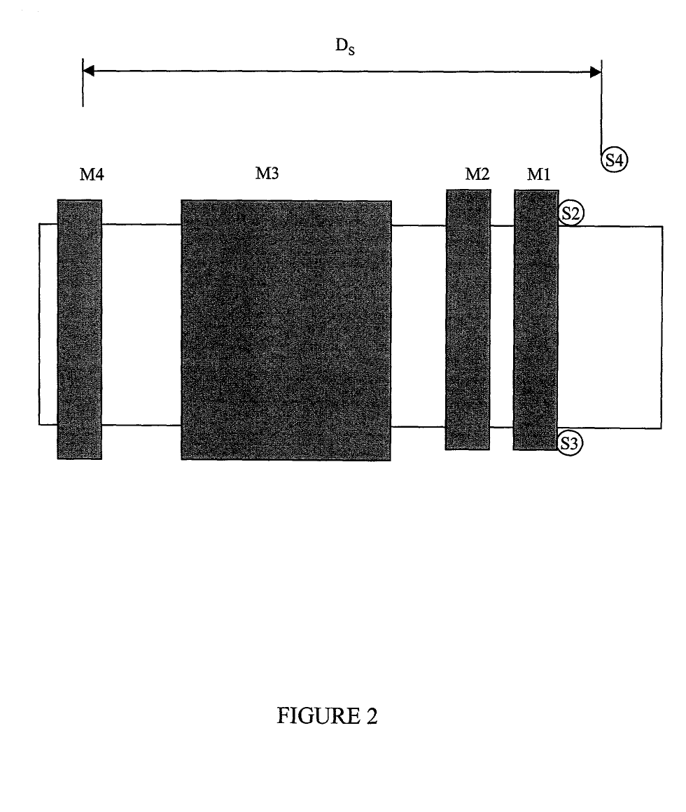

FIG. 2 is a block diagram depicting locations for exemplary embodiments of the present invention in relation to a typical configuration of a conveyance system and a material processing machine. One of ordinary skill in the art would know to alter the relative positioning of the components of the present invention to conform to the parameters and requirements of the conveyance system and the manufacturing process being performed. The conveyance system of FIG. 2 is depicted in the form of a conveyor belt 8 which moves from right to left, as shown in the figure.

In FIG. 2, the boxes M2-M4 represent machines or other object processing devices located along a conveyor belt C1 which carry out various material processing or conveyancing operations (e.g., manufacturing, production assembly, object handling, or the like). In one exemplary embodiment in which FIG. 2 depicts a bottling process, M1 and M2 represent label printing machines for printing two different colors of the bottle label, M3 represents a varnish oven for applying varnish and applying heat to dry it, and M4 represents a bottle stacker machine.

The sensors S2-S4 according to the present invention can be configured at a number of different locations along the conveyor belt C1, depending upon the physical constraints and special requirements of the particular material processing system. In some exemplary embodiments, the sensors S2-S4 can be located proximate the conveyor belt C1 prior to the printing machine M2, as shown in FIG. 2. The configuration shown in the figure, with the sensors S2-S4 located along conveyor belt C1 before printing machine Ml, is particularly suitable when the conveyor belt C1 travels at a relatively high speed. A conveyor belt operating at high transfer velocities may necessitate a certain amount of distance between the sensors S2-S4 of the present invention and the stacker machine M4 in order to reposition or remove an out-of-position object. Further regarding the configuration shown in FIG. 2, even if the transfer velocity of conveyor belt C1 is not a concern, it may be desirable to locate sensors S2-S4 prior to printing machines M1 and M2 and varnish oven M3 simply as a matter of convenience (e.g., if there is ample room for the sensors) so long as the printing machines M1 and M2 and varnish oven M3 do not cause problems with misalignment. In FIG. 2, the proximity distance Dₛ is the distance which the proximity sensor S4 is located away from the processing machine M4.

The physical constraints and special requirements of the material processing system may make it desirable to locate sensors S2-S4 in an alternative embodiment configuration to that shown in FIG. 2. For example, in some factory settings it may be that the bottle stacker machine M4 requires the bottles to be correctly aligned to prevent an unacceptably high percentage of errors from occurring when the bottles are stacked (e.g., to prevent bottle breakage, bottles tipping over). In a system in which the varnish oven M3 tends to cause bottles to be out of position, it is preferred to locate the present invention at a point past the varnish oven M3, but before the stacker machine M4. In other instances, the system may be such that the label printing machines M1 and M2 sometimes cause bottles to become misaligned, but the varnish oven M3 does not cause misalignment. In these instances, the location between label printing machine M2 and varnish oven M3 may prove to be the best choice of location for the present invention. In addition to the aforementioned locations for the sensors S2-S4, those of ordinary skill in the art would know to locate the sensors at other locations along the conveyor belt C1 in order to better adapt the present invention to the physical constraints and special requirements of the material processing system being used.

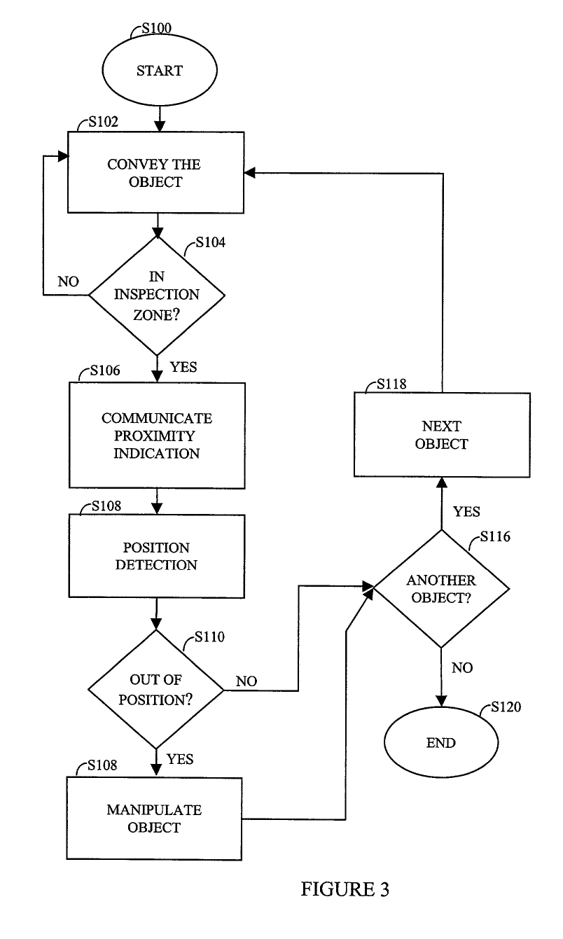

FIG. 3 is a flowchart of a method in accordance with the present invention. The method begins at step S100 and proceeds to step S102 where the object is conveyed. For purposes of explanation, the present invention is discussed in terms of a conveyor belt being used to move the object. However, the object may be conveyed using any of a number of different types of conveyance systems, in accordance with the invention. The method proceeds from step S102 to step S104 where it is determined whether the object being conveyed is in the inspection zone. This is done by using one or more proximity sensors to determine whether the object being conveyed has reached the inspection zone. If an object has not yet reached the inspection zone, the method proceeds in accordance with the “NO” branch from step S104 back to step S102. When it is determined, e.g., by a proximity sensor, that the object is within the inspection zone, the method proceeds from step S104 in accordance with the “YES” branch to step S106.

In step S106 the proximity sensor communicates to the position detection control system that the object being conveyed is within the inspection zone. The communication may take place either wirelessly or via hard-wired signal lines running between the devices. The proximity sensor typically communicates a proximity indication to the programmed logic controller of the system, which in turn communicates the appropriate signals to other components of the system. For example, upon receiving a proximity indication from the proximity sensor, the programmed logic controller sends the appropriate signals to the sensors involved in position detection. In alternative embodiments, the proximity sensor can communicate a proximity indication directly to various components within the system, e.g., the laser position sensors. Upon completing step S106, the method proceeds to step S108.

In step S108 sensors are used to make a position detection. In preferred embodiments, laser sensors are used to detect the position of the object being conveyed upon receiving a signal indicating that the object is in the inspection zone. Once the position detection has been performed in step S108, the method proceeds to step S110 where it is determined whether the object is out of position or not.

If the object is out of position the method proceeds in accordance with the “NO” branch from step S11 to step S116. If in step S110 the object is determined to be out of position, the method proceeds in accordance with the “YES” branch from step S110 to step S18. In step S108 the out of position object is manipulated in a predetermined manner consistent with the manufacturing operation or other material processing operation being performed. For example, in some processes it may be appropriate simply to remove the out of position object from the conveyor belt. In other processes, it may be appropriate to reposition the object for further processing along the conveyor belt. While yet in other processes, it may be appropriate to reposition the object so that it is within the desired position for further processing on the conveyor belt. Upon the completion of step S108, the method proceeds to step S116 where it is determined whether there is another object being conveyed and the method is to be performed on that object.

If, in step S116, it is determined that there is another object, the method proceeds in accordance with the “YES” branch from step S116 to step S118. Then, as the next object moves along the conveyor belt the method loops around from step S118 back to step S102 to handle the next object. However, if in step S116 it is determined that there is not another object to be handled, the method proceeds in accordance with the “NO” branch from step S116 to step S120, where the method ends.

To facilitate an understanding of the invention, many aspects of the invention have been described herein in terms of sequences of actions to be performed by elements of a computer system. It will be recognized that in each of these embodiments, the various actions could be performed by specialized circuits (e.g., discrete logic gates interconnected to perform a specialized function), by program instructions being executed by one or more processors or other such processing devices, or by a combination of these. Moreover, the invention can be embodied entirely within any form of computer readable storage medium having stored thereon an appropriate set of computer instructions that would cause a processing device to carry out the method described herein. Thus, the various aspects of the present invention can be embodied in many different forms, and all such forms are contemplated to be within the scope of the invention.

Although a number of embodiments are described herein for purposes of illustration, these embodiments are not meant to be limiting. Those of skill in the art will recognize numerous modifications and variations that can be made to the illustrated embodiments of the present invention, in light of the above teachings. Such modifications and variations are meant to be covered. It is therefore to be understood that within the invention may be practiced otherwise than as specifically described in conjunction with the illustrative embodiments herein. The scope of the claimed invention is defined by the appended claims, rather than the illustrative embodiments provided herein.

What is claimed is:

1. A method of for detecting and separating an object in a material processing operation, the method comprising steps of:
conveying the object in a production flow direction;
sensing, with a proximity sensor, that the object is in an inspection zone;
communicating a proximity indication from the proximity sensor to a position detector, the proximity indication signifying that the object is in the inspection zone;
performing a position detection by the position detector, the position detection being performed upon reception of the proximity indication from the proximity sensor;
providing a determination that the object is an out-of-position object based upon the position detection by the position detector; and
separating the out-of-position object based upon the determination of the out-of-position object;
wherein the inspection zone is based upon the proximity sensor being a predetermined proximity distance from the object in the production flow direction.

2. The method of claim 1, wherein the predetermined proximity distance is greater than a distance that the out-of-position object is conveyed in the production flow direction during a time it takes to separate the out-of-position object.

3. The method of claim 2, wherein the step of conveying comprises conveying the object on a conveyance system at a predetermined speed in the production flow direction, the method further comprising, prior to the step of separating the out-of-position object, a step of:
slowing down the conveyance system in response to the determination of the out-of-position object.

4. The method of claim 3, wherein the step of separating the out-of-position object comprises:
repositioning the out-of-position object and placing it back on the conveyance system.

5. The method of claim 4, further comprising a step of:
adjusting the position detector using a sensor positioning mechanism.

6. The method of claim 5, wherein the predetermined proximity distance is a distance Dₛ defined by the relationship:
Dₛ=V_{c}×(Aₜ+Pₜ)
wherein V_{c} is a conveyance velocity, Aₜ is a separation time for completing the step of separating the out-of-position object from the conveyance system, and Pₜ is a position detection time.

7. The method of claim 3, further comprising a step of:
speeding up the conveyance system upon completing the step of separating the out-of-position object.

8. The method of claim 2, wherein the position detector comprises two laser sensors.

9. A system for detecting a position of an object in a material processing operation, the system comprising:
a conveyance system configured to convey the object in a production flow direction;
a proximity sensor oriented relative to the a conveyance system to detect the object conveyed into an inspection zone having a length of a predetermined proximity distance in the production flow direction;
a position detector oriented relative to the conveyance system and configured to detect a position of the object; and
a controller in communication with the proximity sensor and the position detector;
wherein the position detector is configured to provide a determination that the object is an out-of-position object to the controller.

10. The system of claim 9, wherein the conveyance system is a conveyor belt.

11. The system of claim 10, wherein the controller is a programmable logic controller.

12. The system of claim 10, wherein the position detector comprises two laser sensors.

13. The system of claim 12, further comprising:
a sensor positioning mechanism disposed in contact with one of the two laser sensors.

14. The system of claim 13, further comprising:
an automatic separation mechanism configured to separate the out-of-position object from the conveyance system.
